(19) United States
(12) Patent Application Publication
(10) Pub. No.: US 2008/0087295 A1
(43) Pub. Date: Apr. 17, 2008

(54) CURLINGIRON MAKING HEAT SOURCE OF HEATED FLUID

(76) Inventor: KANG-SU PARK, SEOUL (KR)

Correspondence Address: IPLA P.A., 3580 WILSHIRE BLVD., 17TH FLOOR, LOS ANGELES, CA, 90010, US

(21) Appl. No.: 11/955,020

(22) Filed: Dec. 12, 2007

Related U.S. Application Data
(63) Continuation of application No. 11/510,906, filed on Aug. 28, 2006.
Application No. 11/510,906 is a continuation-in-part of application No. 10/506,758, filed on Sep. 8, 2004, now abandoned.

(30) Foreign Application Priority Data
Mar. 8, 2002 (KR) 20-2002-0006868
Mar. 7, 2003 (KR) PCT/KR2003/000440

(51) Int. Cl. A45D 1/04; D06F 75/00; H05B 1/00

(52) U.S. Cl. 132/232; 219/225; 219/227; 392/404

(57) ABSTRACT

A curling iron includes a steam generator, a heating unit, a condensed water discharging unit, and a check valve. The steam generator is configured to generate steam using water. The heating unit is configured to receive steam from the steam generator and transfer heat of the steam to a target material. The condensed water discharging unit is configured to collect condensed water from the heating unit and to return the condensed water to the steam generator for recycling the condensed water, and the condensed water discharging unit is disposed between the heating unit and the steam generator. The check valve is configured to prevent the steam in the heating unit to flow into the steam generator and to allow the condensed water in the heating unit to flow into the steam generator, and the check valve is disposed between the condensed water discharging unit and the steam generator.

### REFERENCE TO RELATED APPLICATIONS

This application is a continuation of application Ser. No. 11/510,906 filed Aug. 28, 2006 which is a continuation-in-part of application Ser. No. 10/506,758 filed Sep. 8, 2004 which is abandoned, and all of which are hereby incorporated by reference.

### BACKGROUND OF THE INVENTION

The present invention relates, in general, to a curling iron using heated fluid as its heat source and, more particularly, to a curling iron using heated fluid as its heat source for heating hair, thus maintaining a constant temperature capable of accomplishing a desired curling effect and preventing an excessive increase in its temperature so as to prevent damage to the hair.

As well known to those skilled in the art, conventional curling irons used for curling hair typically use electric coil heaters as heat sources thereof. Such an electric coil heater for the curling irons generates heat when it is operated by electricity, so that the heat is directly transferred from the heater to the hair during a curling process.

However, the conventional curling irons are problematic in that they cannot maintain constant temperatures since they are repeatedly turned on and turned off. The curling effect of the conventional curling irons is thus reduced. In addition, the temperature of the heater of the conventional curling iron is sometimes excessively increased during a curling process, and, in such a case, hair may be thermally damaged.

Rothman disclosed, in U.S. Pat. No. 1,798,760, a steam marcel iron including pressure bars (12, 13), a steam feeding hose (47), a boiler (43), and a steam discharging hose (51).

Rothman stated that “In order to keep a constant flow of steam through the hose 47 so as to prevent condensation therein when the supply of steam to the appliance 11 is cut off, it is necessary that a small quantity of steam be vented continuously. For this purpose a hose 51 is connected with the arm 49 and also with any suitable outlet as, for example, a pet cock 52.”

Murray disclosed, in U.S. Pat. No. 1,738,916, a steam curling iron including a plurality of curling rods connected to the boiler (19) by the tubes (6). Since it uses steam that enters tube (6) and passes through perforations (17), heating the tube, hair, and shoes and steaming the hair, the Murray's steam curling iron discharges the steam into the air and the hair.

In both of the prior arts by Rothman and Murray, water is not recycled but discharged into the air and the hair and then lost from the device. Especially, Rothman's device provided the pet cock (52) to discharge the steam into the air, and the pet cock (52) was installed on a widow sill and connected to the casing (25) of the pressuring bars (12, 13) through a hose (51). Therefore, water was being lost from the device all the time, and it must be supplied from an external source to the device.

### SUMMARY OF THE INVENTION

Accordingly, the present invention has been made keeping in mind the above problems occurring in the prior art, and an object of the present invention is to provide a curling iron which uses heated fluid as its heat source for heating hair, thus maintaining a constant temperature capable of accomplishing a desired curling effect and preventing an excessive increase in its temperature so as to prevent damage to the hair.

In order to accomplish the above object, the present invention provides a curling iron, comprising heated fluid used as a heat source of the iron, a fluid heating unit which heats the fluid used as the heat source, a heating unit which transfers heat of the heated fluid to hair, and thereby curls the hair, and curling tongs which support the heating unit so as to allow the heating unit to heat the hair while the curling tongs grasp the hair.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a curling iron, according to a preferred embodiment of the present invention; and

FIG. 2 is a sectional view of the curling iron of FIG. 1; and

FIG. 3 is a perspective dissectional view of the steam generator.

### DETAILED DESCRIPTION OF THE EMBODIMENTS

Reference should now be made to the drawings, in which the same reference numerals are used throughout the different drawings to designate the same or similar components.

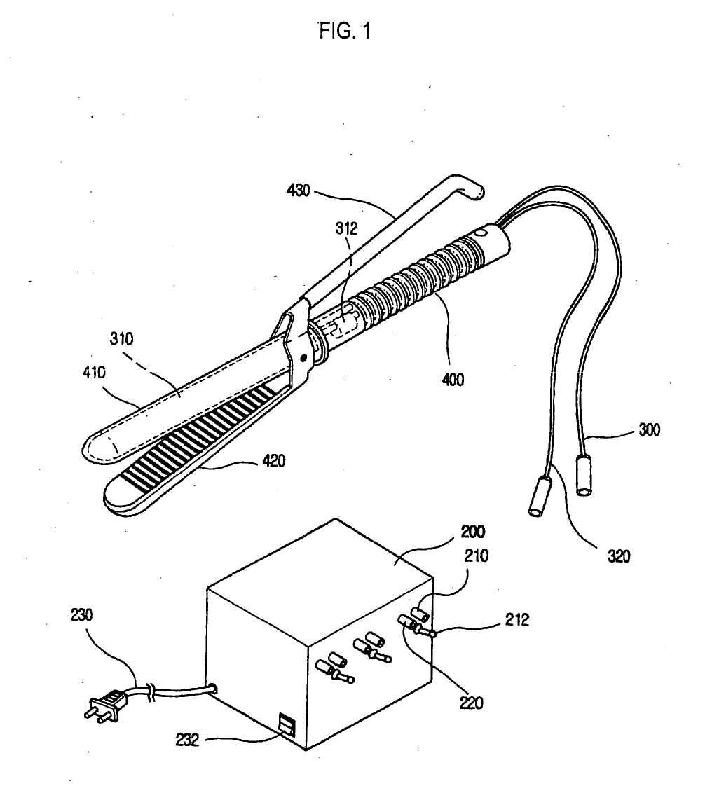

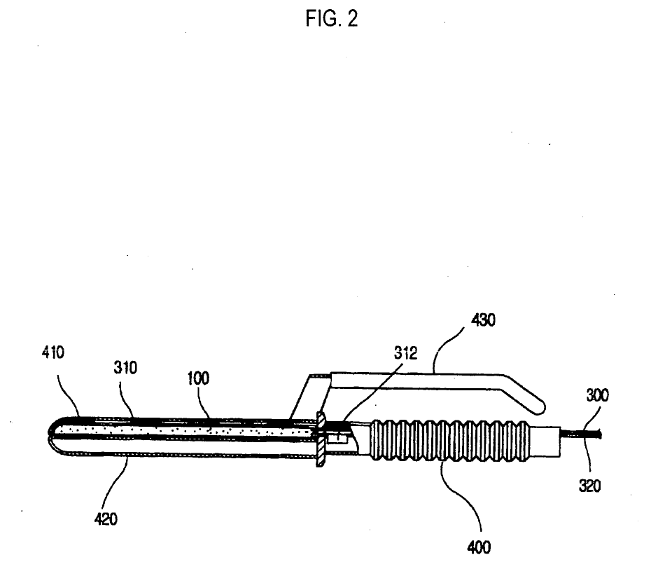

FIG. 1 is a perspective view of a curling iron, according to a preferred embodiment of the present invention. FIG. 2 is a sectional view of the curling iron of FIG. 1.

The curling iron of the present invention uses heated fluid as its heat source for heating a target material, that is, hair, and, in the preferred embodiment of the drawings, the heated fluid is steam 100. The steam 100 is typically increased in its temperature to so that the steam 100 sufficiently heats the hair, without thermally damaging the hair.

The curling iron of the present invention has a fluid heating unit which heats a fluid used as the heat source. In the preferred embodiment, the fluid heating unit is a steam generator 200 which is electrically operated to produce the steam 100. The steam generator 200 includes a plurality of steam outlet ports 210, a plurality of steam supply control switches 212, a plurality of condensed water inlet ports 220, and a plurality of check valves 240 for preventing an undesired flow of the steam 100 into the condensed water inlet ports 220.

A power cord 230 and a power switch 232 are provided at the steam generator 200. The power cord 230 is used for supplying an electric current from an electric power source to the steam generator 200, while the power switch 232 is used for turning on or off the steam generator 200.

The curling iron of the present invention also has a heating unit which transfers heat of the steam 100 to hair, and thereby curls the hair. The heating unit includes a steam feeding tube 300 that is connected to one of the steam outlet ports 210 of the steam generator 200 so as to feed the steam 100 from the steam generator 200 to a steam storing/heat dissipating tube 310. The steam dissipating tube 310 receives the steam 100 fed through the steam feeding tube 300, stores the steam 100 therein, and transfers heat of the steam 100 to the hair. A condensed water discharging unit 312 is connected to the steam storing/heat dissipating tube so as to collect condensed water produced by a condensation of the steam 100 in the steam storing/heat dissipating tube 310, prior to returning the condensed water to the steam generator 200 through one of the condensed water inlet ports 220. A condensed water returning tube 320 is connected at both ends thereof to the condensed water discharging unit 312 and one of the condensed water inlet ports 220, and returns the condensed water from the condensed water discharging unit 312 to the steam generator 200 through the condensed water inlet port 220.

When the steam 100 is fed from the steam generator 200 to the steam storing/heat dissipating tube 310 through the steam feeding tube 300, the steam 100 heats the steam feeding tube so that the heated tube may burn a user when the user accidentally comes into contact with the heated tube 300. In an effort to overcome such a problem, it is preferred to finish the outer surface of the steam feeding tube 300 with a thermal insulating material.

The steam storing/heat dissipating tube is preferably produced by using a metal having high thermal conductivity, and has a shape which allows the steam dissipating tube 310 to come into effective contact with the hair during a curling process.

The curling iron of the present invention further includes curling tongs which support the heating unit so as to allow the heating unit to heat the hair while the curling tongs grasp the hair. The curling tongs are comprised of a handle 400, a main arm 410, a sub-arm 420, and a lever 430. The handle 400 is used as a grip of the curling tongs, with a part of the steam feeding tube 300 axially passing through the handle 400. The main arm 410 is connected to the handle 400, and supports the steam storing/heat dissipating tube 310 therein.

The sub-arm 420 is hinged to the main arm 410 such that the sub-arm 420 comes into contact with the steam storing/heat dissipating tube of the main arm 410 to grasp the hair while the hair is heated by the steam heat, or moves away from the steam storing/heat dissipating tube 310 to release the hair after heating the hair. The lever 430 is connected to the sub-arm 420 so as to allow the user to rotate the sub-arm 420 relative to the main arm 410 around the hinged joint of the two arms 410 and 420.

Since the steam generator 200 has the plurality of steam outlet ports 210 and the plurality of condensed water inlet ports 220, as described above, it is possible to connect a plurality of steam feeding tubes 300 and a plurality of condensed water returning tubes 320 to the steam generator 200, at the same time. Therefore, two or more curling tongs may be used with the steam generator 200 at the same time, so that two or more users may simultaneously curl the hair of several persons by use of a single steam generator 200. The curling irons of the present invention are thus preferably used in beauty shops or other places in which a plurality of hairdressers curl the hair of several persons at the same time.

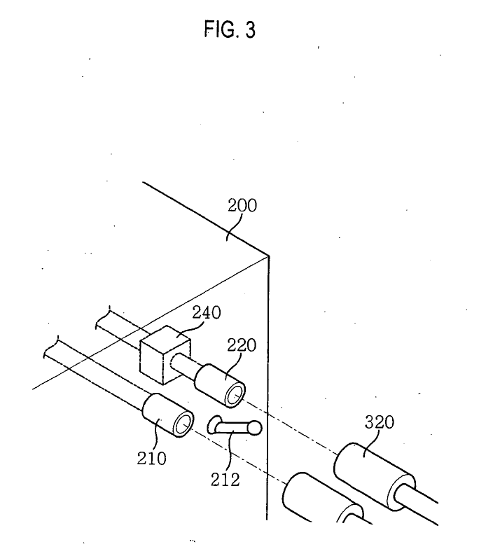

FIG. 3 is a perspective dissectional view of the steam generator 200 showing the flow of steam in the curling iron according to the invention. The steam 100 from the steam generator 200 is supplied into the steam feeding tube 300 connected to the steam outlet ports 210, and then transferred to the steam storing/heat dissipating tube 310.

Water condensed from the steam 100 returns to the steam generator 200 through the condensed water returning tube 320 and the condensed water inlet port 220.

With the steam supply control switch 212 in FIG. 3 on, the steam 100 is passed through the steam feeding tube 300. The check valves 240 release the steam 100 through the condensed water inlet port 220.

The operational effect of the curling iron of the present invention will be described herein below, with reference to the drawings.

At first, the power switch 232 of the steam generator 200 is turned on to allow the steam generator 200 to produce steam 100—therein. Thereafter, the steam feeding tube 300 is connected to a selected one of the steam outlet ports 210 of the steam generator 200, and the condensed water returning tube 320 is connected to a selected one of the condensed water inlet ports 220.

When a steam supply control switch 212 associated with the selected steam outlet port 210 is turned on, the steam 100 flows from the steam generator 200 into the steam feeding tube through the steam outlet port 210. =p The steam 100 is, thereafter, fed through the steam feeding tube 300 into the steam dissipating tube that is supported by the main arm of the curling tongs. At the steam storing/heat dissipating tube the steam 100 heats the tube so that the tube radiates heat to the outside.

Therefore, when the user who grips the handle 400 manipulates the lever 430 to close the main and sub-arms 410 and 420, the two arms 410 and 420 grasp the hair while the steam storing/heat dissipating tube heats the hair by use of the steam heat, thus curling the hair.

During the curling process, the temperature of the steam 100 inside the steam storing/heat dissipating tube 310 is reduced, so that the steam 100 is condensed to produce condensed water. The condensed water is primarily collected in the condensed water discharging unit 312, and sequentially passes through the condensed water returning tube 320 and the condensed water inlet port 220, thus being returned to the steam generator 200. The condensed water discharging unit 312 is designed to discharge only the condensed water from the steam storing/heat dissipating tube while preventing leakage of the steam 100 from the steam storing/heat dissipating tube 310 into the condensed water returning tube 320.

The steam 100 is condensed to water, which returns to the steam generator 200 through the condensed water returning tube 320 and the condensed water inlet port 220.

Another aspect of the invention provides a curling iron including a steam generator 200, a heating unit, a condensed water discharging unit 312, and a check valve 240.

The steam generator 200 is configured to generate steam 100 using water. The steam generator 200 may use electrical energy as power.

The heating unit is configured to receive steam 100 from the steam generator 200 and transfer heat of the steam 100 to a target material. The target material may include hair.

The condensed water discharging unit 312 is configured to collect condensed water from the heating unit and to return the condensed water to the steam generator 200 for recycling the condensed water, and the condensed water discharging unit 312 is disposed between the heating unit and the steam generator 200. Recycling water is desirable considering possibly frequent refilling of water in the steam generator 200 or difficulty of discarding the condensed water or used steam. Recycling water may make the usage environment of the curling iron comfortable and clean.

The check valve 240 is configured to prevent the steam 100 in the heating unit to flow into the steam generator 200 and to allow the condensed water in the heating unit to flow into the steam generator 200, and the check valve 240 is disposed between the condensed water discharging unit 312 and the steam generator 200. The check valve 240 is necessary for the condensed water discharging unit 312 to work properly. Without the check valve 240, recycling water may be inefficient and heat of steam may be wasted.

The heating unit may comprise: a steam storing/heat dissipating tube 310 configured to receive the steam 100 from the steam generator 200, store the steam 100 therein, and transfer heat of the steam 100 to the target material, for example, hair; and curling tongs configured to support the heating unit so as to allow the heating unit to heat the target material while the curling tongs grasp the target material. The condensed water discharging unit 312 may be connected to the steam storing/heat dissipating tube 310 so as to collect and discharge the condensed water in the steam storing/heat dissipating tube 310 as shown in FIG. 1.

The curling iron may further comprise: a steam feeding tube 300 connected between the steam generator 200 and the heating unit, wherein the steam feeding tube 300 comprises a thermal insulating material on outer walls; and a condensed water returning tube 320 connected between the condensed water discharging unit 312 and the check valve 240. The condensed water returning tube 320 may be configured to return the condensed water from the condensed water discharging unit 312 to the steam generator 200.

The check valve 240 may be disposed closer to the steam generator 200 rather than the heating unit. In certain embodiments, the check valve 240 may be disposed in a same box as the steam generator 200.

The condensed water discharging unit 312, the condensed water returning tube 320, and the check valve 240 may be configured to recycle water substantially in the curling iron.

### INDUSTRIAL APPLICABILITY

As described above, the present invention provides a curling iron using heated fluid as its heat source for heating hair. The curling iron of the present invention is comprised of a fluid heating unit which heats the fluid to produce steam used as the heat source, a heating unit which transfers heat of the steam to hair, and thereby curls the hair, and curling tongs which support the heating unit so as to allow the heating unit to heat the hair while the curling tongs grasp the hair. Since the curling iron uses heated fluid as its heat source for heating hair, the curling iron maintains a constant temperature capable of accomplishing a desired curling effect and prevents an excessive increase in its temperature so as to prevent damage to the hair.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A curling iron comprising:
a steam generator configured to generate steam using water;
a heating unit configured to receive steam from the steam generator and to transfer heat of the steam to a target material;
a condensed water discharging unit configured to collect condensed water from the heating unit and to return the condensed water to the steam generator for recycling the condensed water, wherein the condensed water discharging unit is disposed between the heating unit and the steam generator; and
a check valve configured to prevent the steam in the heating unit to flow into the steam generator and to allow the condensed water in the heating unit to flow into the steam generator, wherein the check valve is disposed between the condensed water discharging unit and the steam generator.

2. The curling iron of claim 1, wherein the heating unit comprises:
a steam storing/heat dissipating tube configured to receive the steam from the steam generator, store the steam therein, and transfer heat of the steam to the target material; and
curling tongs configured to support the heating unit so as to allow the heating unit to heat the target material while the curling tongs grasp the target material.

3. The curling iron of claim 2, wherein the condensed water discharging unit is connected to the steam storing/heat dissipating tube so as to collect and discharge the condensed water in the steam storing/heat dissipating tube.

4. The curling iron of claim 1, further comprising:
a steam feeding tube connected between the steam generator and the heating unit, wherein the steam feeding tube comprises a thermal insulating material on outer walls; and
a condensed water returning tube connected between the condensed water discharging unit and the check valve.

5. The curling iron of claim 4, wherein the condensed water returning tube is configured to return the condensed water from the condensed water discharging unit to the steam generator.

6. The curling iron of claim 1, wherein the check valve is disposed closer to the steam generator rather than the heating unit.

7. The curling iron of claim 6, wherein the check valve is disposed in a same box as the steam generator.

8. The curling iron of claim 1, wherein the condensed water discharging unit, the condensed water returning tube, and the check valve are configured to recycle water substantially in the curling iron.
